(19) United States
(12) Patent Application Publication
(10) Pub. No.: US 2020/0019361 A1
(43) Pub. Date: Jan. 16, 2020

(54) JOB-RELATED NOTIFICATION OUTPUT APPARATUS, MULTIFUNCTION PERIPHERAL, IMAGE FORMING APPARATUS, AND JOB-RELATED NOTIFICATION OUTPUT METHOD

(71) Applicant: SHARP KABUSHIKI KAISHA, Sakai City (JP)

(72) Inventor: HIROYUKI ATAKA, Sakai City (JP)

(21) Appl. No.: 16/504,873

(22) Filed: Jul. 8, 2019

(30) Foreign Application Priority Data
Jul. 10, 2018 (JP) 2018-130610

(51) Int. Cl. G06F 3/12

(52) U.S. Cl. CPC G06F 3/1259; G06F 3/1287; G06F 3/1207

(57) ABSTRACT

A job-related notification output apparatus includes a consecutive job end notification unit that, when consecutive jobs end, outputs notification indicating that the consecutive jobs end, and a single job end notification unit that, when a single job ends, outputs notification indicating that the single job ends.

### BACKGROUND

### 1. Field

The present disclosure relates to a job-related notification output apparatus, a multifunction peripheral, an image forming apparatus, and a job-related notification output method.

### 2. Description of the Related Art

In a configuration of the related art as illustrated in FIG. 1, when a printing apparatus 792, such as a multifunction peripheral, which prints print data from a host apparatus, such as a computer 790#1, 790#2, . . . or 790# N, through a network 794 is a little distant, a state of the printing apparatus 792 is difficult to be grasped. Therefore, predetermined sound is reproduced in accordance with the state of the printing apparatus 792 to enable checking of the state of the printing apparatus 792 by sound notification. In particular, since a user desires to go for a printed matter after checking completion of a print job executed by himself or herself, in general, the completion of the print job is notified by sound so that the completion of the print job is recognized to enable checking of the completion of the print job by sound notification.

Japanese Unexamined Patent Application Publication No. 2002-234236 proposes a method of notifying a print status corresponding to an individual print job to enable an individual user to easily determine the print status.

There may be a case where, however, when a plurality of print jobs are consecutively executed, sound notification is performed every time a print job is completed, and sound is frequently output and is noisy.

A specific example is indicated in FIG. 1. The multifunction peripheral 792 executes printing in accordance with a request to execute a print job from the computer 790#1, 790#2, 790# N, or the like connected through the network 794. Then, every time a print job (hereinafter, simply referred to as a “job”) is completed, the multifunction peripheral 792 outputs job end sound for notifying the completion to a user of the computer 790#1, 790#2, or 790# N at a level at which the sound reaches the user.

For example, as illustrated in FIG. 2, regardless of whether or not a job #1 to a job #11 are consecutive, the multifunction peripheral outputs, the job end sound every time each of the jobs ends.

Thus, it is desirable to provide a job-related notification output apparatus that outputs one related to a job to a degree not to annoy a person who is able to perceive the one, a multifunction peripheral, an image forming apparatus, and a job-related notification output method.

### SUMMARY

According to an aspect of the disclosure, there is provided a job-related notification output apparatus including: a consecutive job end notification unit that, when consecutive jobs end, outputs notification indicating that the consecutive jobs end; and a single job end notification unit that, when a single job ends, outputs notification indicating that the single job ends.

According to an aspect of the disclosure, there is provided a multifunction peripheral including the job-related notification output apparatus.

According to an aspect of the disclosure, there is provided an image forming apparatus including the job-related notification output apparatus.

According to an aspect of the disclosure, there is provided a job-related notification output method including: outputting, when consecutive jobs end, notification indicating that the consecutive jobs end; and outputting, when a single job ends, notification indicating that the single job ends.

According to an aspect of the disclosure, there is provided a recording medium storing a program that causes a computer to function as the job-related notification output apparatus.

### BRIEF DESCRIPTION OF THE DRAWINGS

FIG. 1 is a view in which a printing apparatus and a plurality of computers are connected to each other via a network;

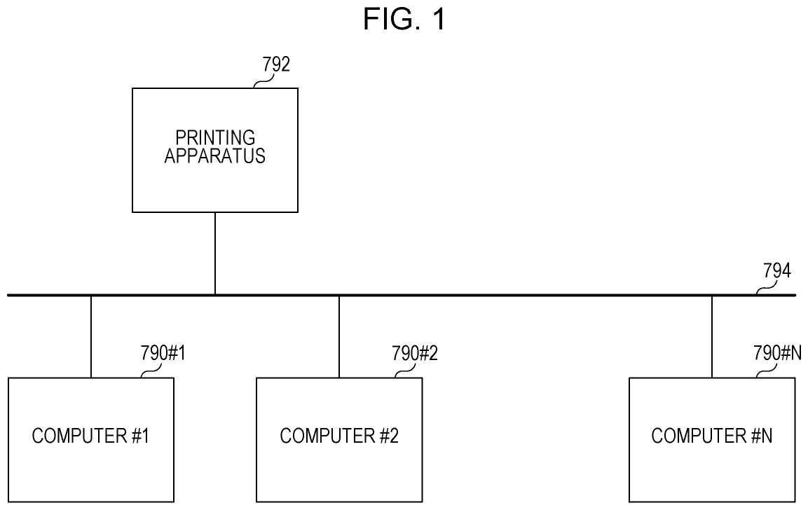

FIG. 2 is a conceptual view illustrating a timing when job end sound is output in an example of the related art;

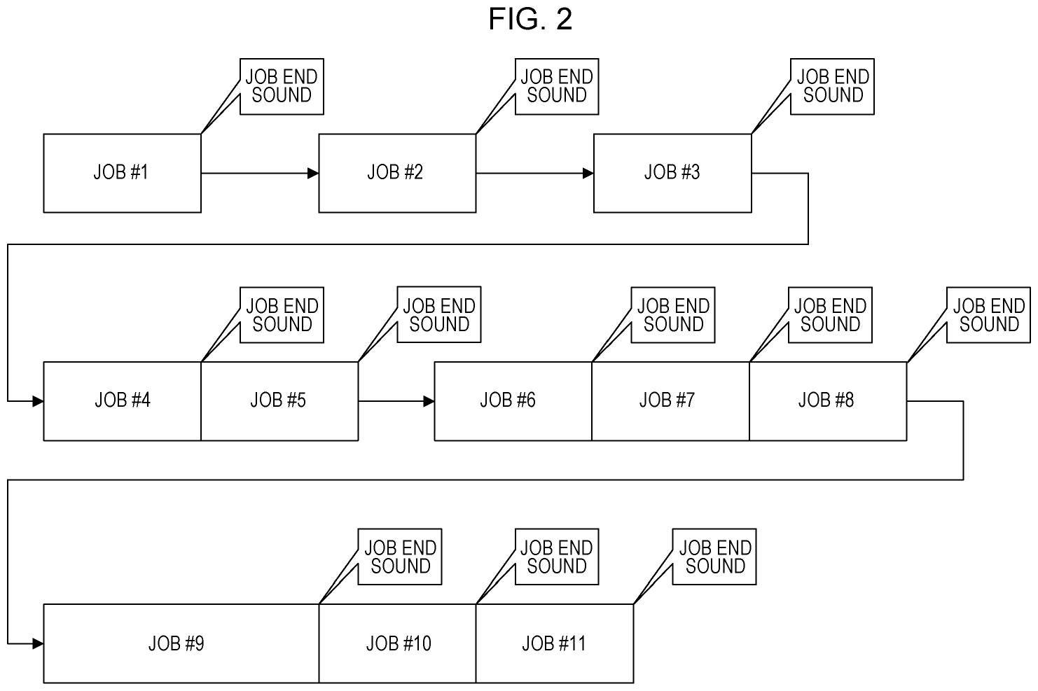

FIG. 3 is a conceptual view illustrating sound that is output in a first embodiment of the disclosure;

FIG. 4 is a flowchart for explaining a job-related notification output method according to the first embodiment of the disclosure;

FIG. 5 is a conceptual view illustrating sound that is output in a second embodiment of the disclosure;

FIG. 6 is a flowchart for explaining a job-related notification output method according to the second embodiment of the disclosure;

FIG. 7 is a conceptual view illustrating sound that is output in a third embodiment of the disclosure;

FIG. 8 is a flowchart for explaining a job-related notification output method according to the third embodiment of the disclosure;

FIG. 9 is a conceptual view illustrating sound that is output in a fourth embodiment of the disclosure;

FIG. 10 is a flowchart for explaining a job-related notification output method according to the fourth embodiment of the disclosure;

FIG. 11 is a conceptual view illustrating sound that is output in a fifth embodiment of the disclosure;

FIG. 12 is a flowchart for explaining a job-related notification output method according to the fifth embodiment of the disclosure;

FIG. 13 is a functional block diagram illustrating a configuration of a job-related notification output apparatus according to a seventh embodiment of the disclosure;

FIG. 14 is a conceptual sectional view of a multifunction peripheral according to an eighth embodiment of the disclosure; and

FIG. 15 is a functional block diagram of the multifunction peripheral according to the eighth embodiment of the disclosure.

### DESCRIPTION OF THE EMBODIMENTS

Embodiments of the disclosure will be described in detail below with reference to the drawings.

### First Embodiment

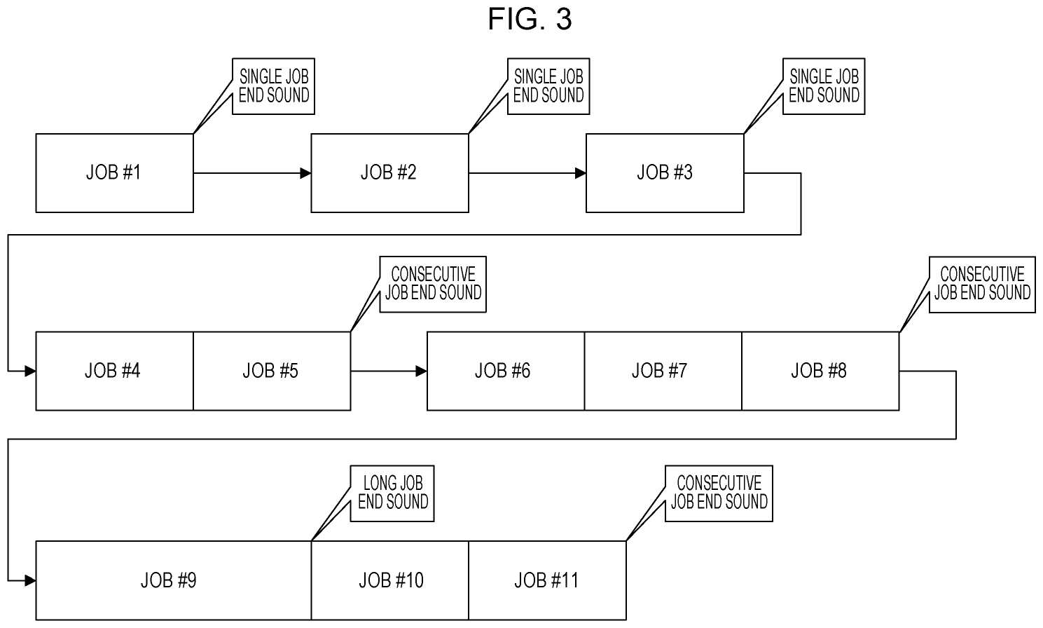

According to a first embodiment, as illustrated in FIG. 3, when jobs are consecutive, a multifunction peripheral outputs consecutive job end sound every time a last job of the consecutive jobs ends, and when the jobs are not consecutive, the multifunction peripheral outputs single job end sound every time each of the jobs ends. Thus, the multifunction peripheral does not output jab end sound when a job other than the last job included in the consecutive jobs ends.

In an example of FIG. 3, since a job #4 and a job #5 are consecutive, the job end sound is not output when the job #4 ends, and the consecutive job end sound is output when the job #5 ends.

Further, since a job #6, a job #7, and a job #8 are consecutive, the job end sound is not output when the job #6 and the job #7 end, and the consecutive job end sound is output when the job #8 ends.

Furthermore, since a job #9, a job #10, and a job #11 are consecutive, the job end sound is not output when the job #9 and the job #10 end, and the consecutive job end sound is output when the job #11 ends.

Since a job #1, a job #2, and a job 3 are not consecutive and are each a single job, the single job end sound is output every time each of the jobs ends.

Further, since the job #9 is a job that takes a predetermined time or more, loner job end sound is output.

Next, a job-related notification output method according to the first embodiment will be described.

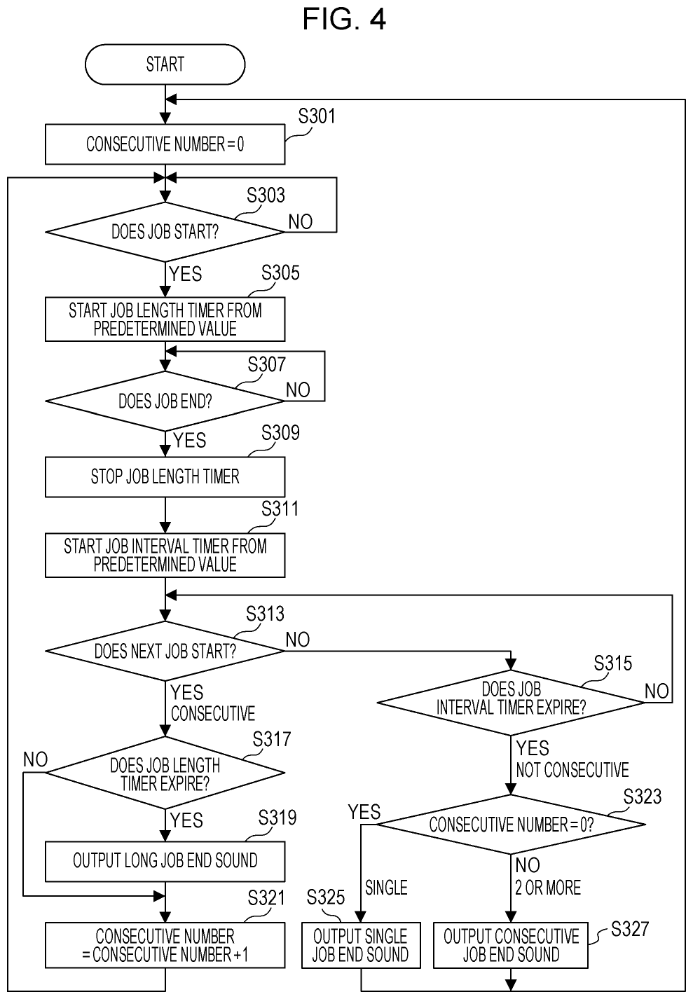

With reference to FIG. 4, first, a “consecutive number” which is a variable to count the number of consecutive jobs is initialized to zero (step S301).

When a job starts (YES at step S303), a job length timer is started from a predetermined value for the job length timer (step S305). From this point, a job length counter starts counting down.

Next, when the job is completed (YES at step S307), the job length timer is stopped (step S309).

Next, a job interval timer is started from a predetermined value for the job interval timer (step S311).

Next, start of a next job or timeout of the job interval timer is waited (step S313 or S315).

When a next job starts before the job interval timer expires (YES at step S313), whether the job length timer expires is checked, and when the job length timer expires (YES at step S317), the long job end sound is output (step S319). After the consecutive number is increased by 1 (step S321), the procedure returns to step S303. At step S319, the single job end sound may be output.

When the job interval timer expires before the next job starts (YES at step S315), whether the “consecutive number” is zero is checked, and when the “consecutive number” is zero (YES at step S323), the single job end sound is output (step S325), and then, the procedure returns to step S301. When the “consecutive number” is not zero (NO at step S323), the consecutive job end sound is output (step S327), and then, the procedure returns to step S301.

### Second Embodiment

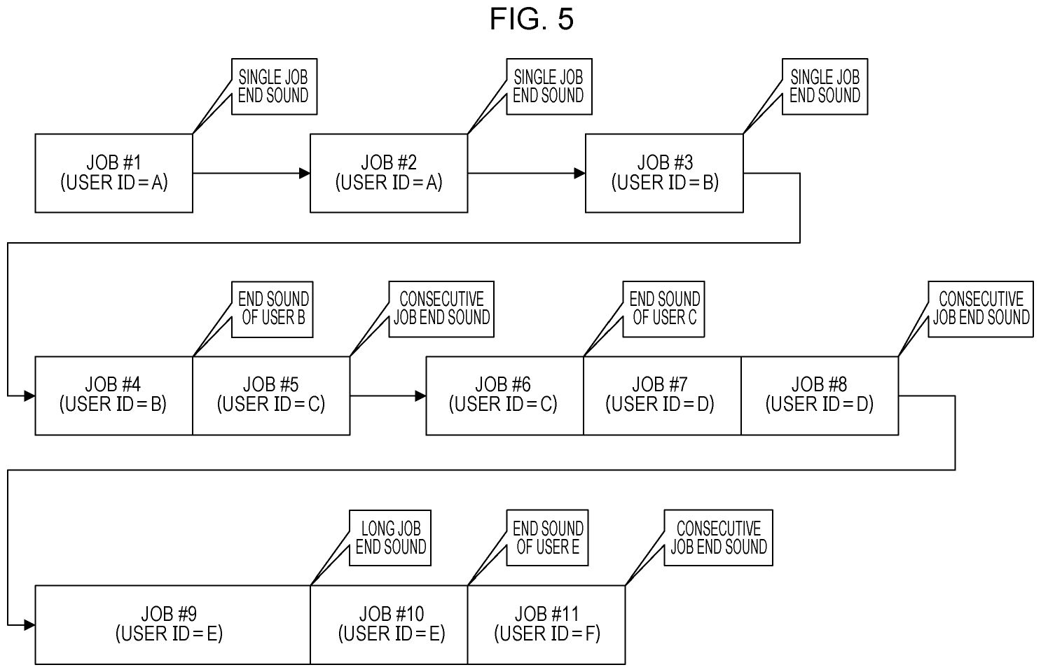

According to a second embodiment, as illustrated in FIG. 5, when jobs are consecutive, the multifunction peripheral outputs the consecutive job end sound every time a last job of the consecutive jobs ends, and when the jobs are not consecutive, the multifunction peripheral outputs the single job end sound every time each of the jobs ends. Thus, the multifunction peripheral does not output the job end sound when a job other than the last job included in the consecutive jobs ends.

In the second embodiment, every time a user of a job in the consecutive jobs changes, user end sound corresponding to a previous user is output. Note that, for example, the user is able to be identified by a computer transmitting the job to the multifunction peripheral.

In an example of FIG. 5, since a job #4 and a job #5 are consecutive, the job end sound is not output when the job #4 ends, and the consecutive job end sound is output when the job #5 ends.

Further, since a job #6, a job #7, and a job #8 are consecutive, the job end sound is not output when the job #6 and the job #7 end, and the consecutive job end sound is output when the job #8 ends.

Furthermore, since a job #9, a job #10, and a job #11 are consecutive, the job end sound is not output when the #9 and the job #10 end, and the consecutive job end sound is output when the job #11 ends.

Though the job #4 and the job #5 are consecutive, a user of the job #4 is B and a user of the job #5 is C, and therefore, end sound of the user B is output when the job #4 ends.

Though the job # 6, the job #7, and the job #8 are consecutive, a user of the job #6 is C and a user of the job #7 and the job #8 is D, and therefore, end sound of the user C is output when the job #6 ends.

Though the job #9, the job #10, and the job #11 are consecutive, a user of the job #9 and the job #10 is E and a user of the job #11 is F, and therefore, end sound of the user F is output when the job #10 ends.

Since a job #1, a job #2, and a job #3 are not consecutive and are each a single job, the single job end sound is output every time each of the jobs ends.

Note that, user end sound may be output also in a case of the single job. That is, end sound of the user A may be output when the job #2 ends.

The user end sound may be output also in a case of consecutive jobs.

Further, instead of end sound corresponding to a specific user, end sound simply indicating that a user changes may be output.

Next, a job-related notification output method according to the second embodiment will be described.

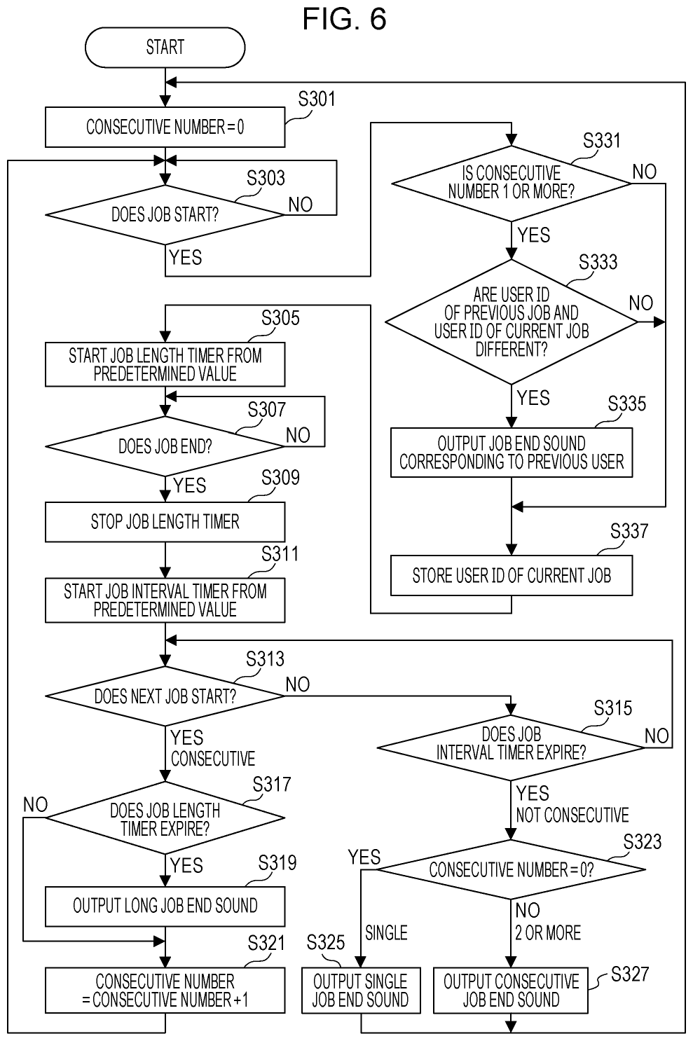

With reference to FIG. 6, first, a “consecutive number” which is a variable to count the number of consecutive jobs is initialized to zero (step S301).

When a job starts (YES at step S303), whether the consecutive number is 1 or more and whether a user ID of a previous job and a user ID of a current job are different are checked, and when the consecutive number is 1 or more and the user IDs are different (YES at step S331 and YES at step S333), job end sound corresponding to a previous user is output (step S335). Job end sound not corresponding to a specific user may be output.

Next, the user ID of the current job is stored (step S337).

Next, the job length timer is started from the predetermined value for the job length timer (step S305). From this point, the job length counter starts counting down.

Next, when the job is completed (YES at step S307), job length timer is stopped (step S309).

Then, the job interval timer is started from the predetermined value for the job interval timer (step S311).

Next, start of a next job or timeout of the job interval timer is waited (step S313 or S315).

When a next job starts before the job interval timer expires (YES at step S313), whether the job length timer expires is checked, and when the job length timer expires (YES at step S317), the long job end sound is output (step S319). After the consecutive number is increased by 1 (step S321), the procedure returns to step S303. At step S319, the single job end sound may be output.

When the job interval timer expires before the next job starts (YES at step S315), whether the “consecutive number” is zero is checked, and when the “consecutive number” is zero (YES at step S323), the single job end sound is output (step S325), and then, the procedure returns to step S301. When the “consecutive number” s not zero (NO at step S323), the consecutive job end sound is output (step S327), and then, the procedure returns to step S301.

To output the user end sound also in the case of a single job, YES is given at all times in the determination of step S331.

### Third Embodiment

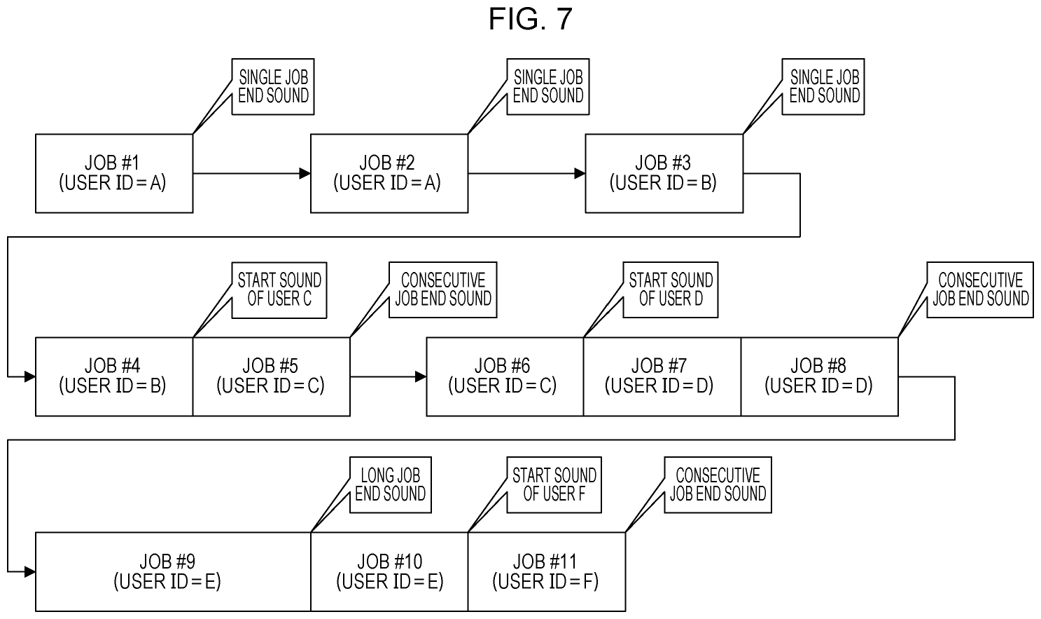

According to a third embodiment, as illustrated in FIG. 7, when jobs are consecutive, the multifunction peripheral outputs the consecutive job end sound every time a last job of the consecutive jobs ends, and when the jobs are not consecutive, the multifunction peripheral outputs the single job end sound every time each of the jobs ends. Thus, the multifunction peripheral does not output the job end sound when a job other than the last job included in the consecutive jobs ends.

Further, in the third embodiment, every time a user of a job in the consecutive jobs changes, user end sound corresponding to a current user is output.

In an example of FIG. 7, since a job #4 and a job #5 are consecutive, the job end sound is not output when the job #4 ends, and the consecutive job end sound is output when the job #5 ends.

Further, since a job #6, a job #7, and a job #8 are consecutive, the job end sound is not output when the job #6 and the job #7 end, and the consecutive job end sound is output when the job #8 ends.

Furthermore, since a job #9, a job #10, and a job #11 are consecutive, the job end sound is not output when the job #9 and the job #10 end, and the consecutive job end sound is output when the job #11 ends.

Though the job #4 and the job #5 are consecutive, a user of the job #4 is B and a user of the job #5 is C, and therefore, start sound of the user C is output when the job #4 ends (that is, when the job #5 starts).

Though the job #6, the job #7, and the job #8 are consecutive, a user of the job #6 is C and a user of the job #7 and the job #8 is D, and therefore, start sound of the user D is output when the job #6 ends (that is, when the job #7 starts).

Though the job #9, the job #10, and the job #11 are consecutive, a user of the job #9 and the job #10 is F and a user of the job 411 is F, and therefore, start sound of the user F is output when the job #10 ends (that is, when the job #11 starts).

Since a job #1, a job #2, and a job #3 are not consecutive and are each a single job, the single job end sound is output every time each of the jobs ends.

Note that, user end sound may be output also in the case of the single job. That is, end sound of the user B may be output when the job #3 starts.

Further, instead of start sound corresponding to a specific user, start sound simply indicating that a user changes may be output.

Next, a job-related notification output method according to the third embodiment will be described.

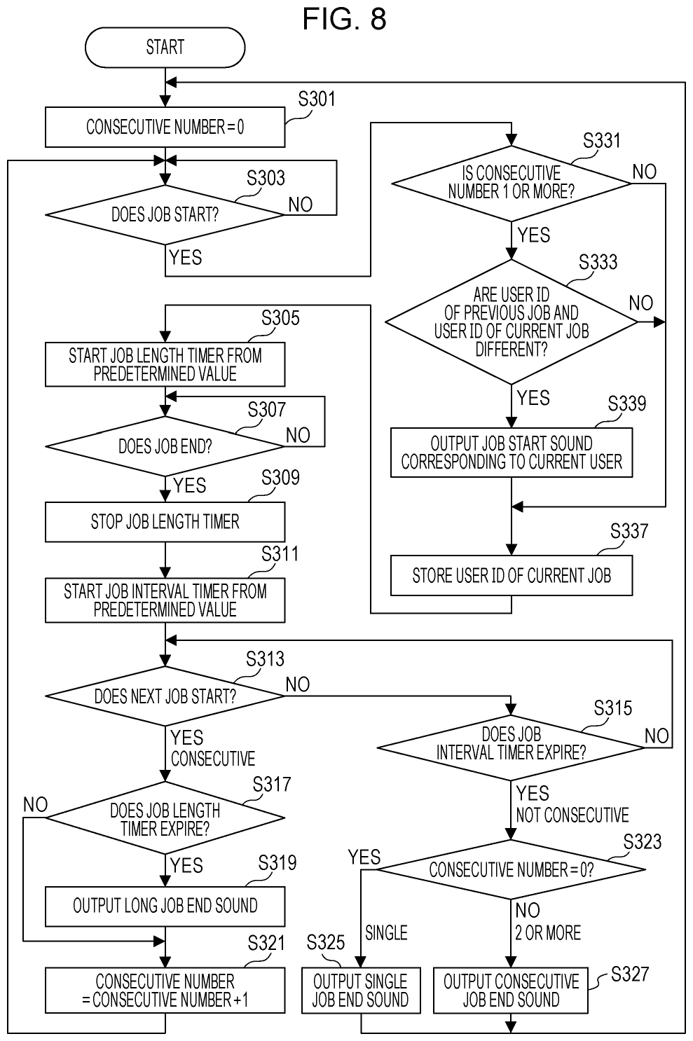

As is clear from FIG. 6 corresponding to the second embodiment and FIG. 8 corresponding to the third embodiment, the third embodiment is different from the second embodiment only in that step S335 at which job end sound corresponding to a previous user is output is replaced with step S339 at which job start sound corresponding to a current user is output. Since the other steps are common, redundant description will be omitted.

At step S339, job start sound not corresponding to a specific user may be output.

### Fourth Embodiment

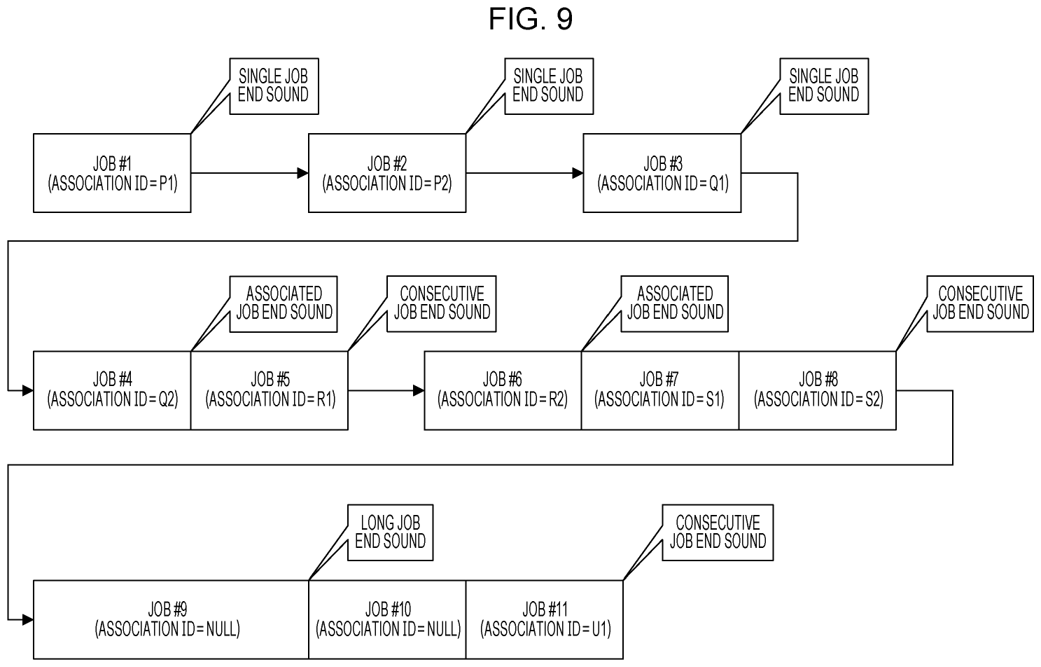

According to a fourth embodiment, as illustrated in FIG. 9, when jobs are consecutive, the multifunction peripheral outputs the consecutive job end sound every time a last job of the consecutive jobs ends, and when the jobs are not consecutive, the multifunction peripheral outputs the single job end sound every time each of the jobs ends. Thus, the multifunction peripheral does not output, the job end sound when a job other than the last job included in the consecutive jobs ends.

Further, in the fourth embodiment, every time an associated job in the consecutive jobs ends, associated job end sound corresponding to a previous associated job is output.

In an example of FIG. 9, since a job #4 and a job #5 are consecutive, the job end sound is not output when the job #4 ends, and the consecutive job end sound is output when the job #5 ends.

Further, since a job #6, a job #7, and a job #8 are consecutive, the job end sound is not output when the #6 and the job #7 end, and the consecutive job end sound is output when the job #8 ends.

Furthermore, since a job a job #10, and a job #11 are consecutive, the job end sound is not output when the job #9 and the job #10 end, and the consecutive job end sound is output when the job #11 ends.

Though the job #4 and the job #5 are consecutive, an association ID of the job #4 is Q2, an association ID of the job #5 is R1, and the job #4 and the job #5 are not associated with each other, and therefore, end sound of an associated job Q is output when the job #4 ends.

Though the job #6, the job #7, and the job #8 are consecutive, an association ID of the job #6 is R2, an association ID of the job #7 is S1, an association ID of the job #8 is S2, and the job #6 and the job #7 are not associated with each other, and therefore, end sound of an associated job F is output when the job #6 ends.

Though the job #9, the job #10, and the job #11 are consecutive, an association ID of the job #9 is NULL, an association ID of the job #10 is NULL, an association ID of the jot #11 is U1, and the job #10 and the job #11 are not associated with each other. However, since the job #10 is not originally associated with another job, the associated job end sound is not output when the job #10 ends.

Since a job #1, a job #2, and a job #3 are not consecutive and are each a single job, the single job end sound is output every time each of the jobs ends.

Note that, associated job end sound may be output when a job which is not originally associated with another job ends and a job which is mutually associated with a job starts from next time. In the example of FIG. 9, for example, associated job end sound corresponding to NULL may be output when the job #10 ends.

Next, a job-related notification output method according to the fourth embodiment will be described.

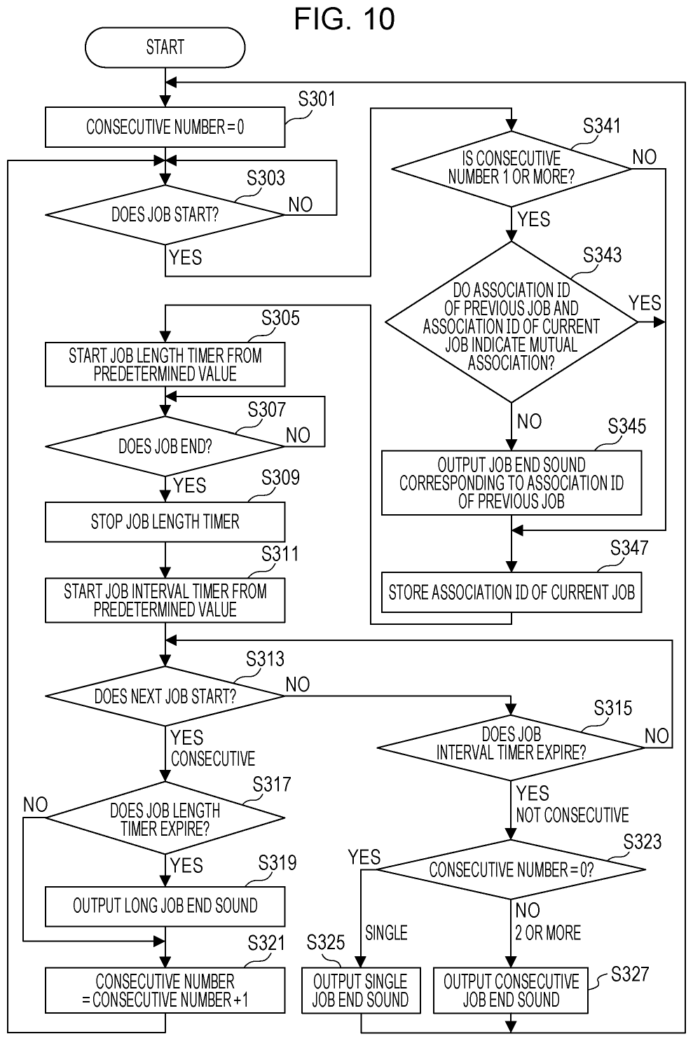

With reference to FIG. 10, first, a “consecutive number” which is a variable to count the number of consecutive jobs is initialized to zero (step S301).

When a job starts (YES at step S303), whether the consecutive number is 1 or more and whether an association ID of a previous job and an association ID of a current job indicate mutual association between the jobs are checked. When the consecutive number is 1 or more but the association IDs do not indicate mutual association (YES at step S341 but NO at step S343), job end sound corresponding to the previous association ID is output (step S345).

Note that, a value of an association ID when there is no association is set as a predetermined value and a value of an association ID when there is association is set as any value other than the predetermined value. Association IDs of jobs that are associated with each other have the same value or values by which it is possible to determine that the jobs are associated with each other. In a computer, print jobs of files in the same folder may be determined to be associated with each other, print jobs of files having the same date may be determined to be associated with each other, files of the same type may be determined to be associated with each other, files of the same application may be determined to be associated with each other, whether or not files are associated with each other nay be determined by a combination thereof, or whether or not files are associated with each other may be determined by association IDs set by a user or a predetermined application.

When the previous association ID is NULL, job end sound corresponding to NULL may be output or nothing may be output at step S345.

Next, the association ID of the current job is stored (step S347).

Next, the job length timer is started from the predetermined value for the job length timer (step S305). From this point, the job length counter starts counting down.

Next, when the job is completed (YES at step S307), the job length timer is stopped (step S309).

Then, the job interval timer is started from the predetermined value for the job interval timer (step S311).

Next, start of a next job or timeout of the job interval timer is waited (step S313 or S315).

When a next job starts before the job interval timer expires (YES at step S313), whether the job length timer expires is checked, and when the job length timer expires (YES at step S317), the long job end sound is output (step S319). After the consecutive number is increased by 1 (step S321), the procedure returns to step S303. At step S319, the single job end sound may be output.

When the job interval timer expires before the next job starts (YES at step S315), whether the “consecutive number” is zero is checked, and when the “consecutive number” is zero (YES at step S323), the single job end sound is output (step S325), and then, the procedure returns to step S301. When the “consecutive number” is not zero (NO at step S323), the consecutive job end sound is output (step S327), and then, the procedure returns to step S301.

### Fifth Embodiment

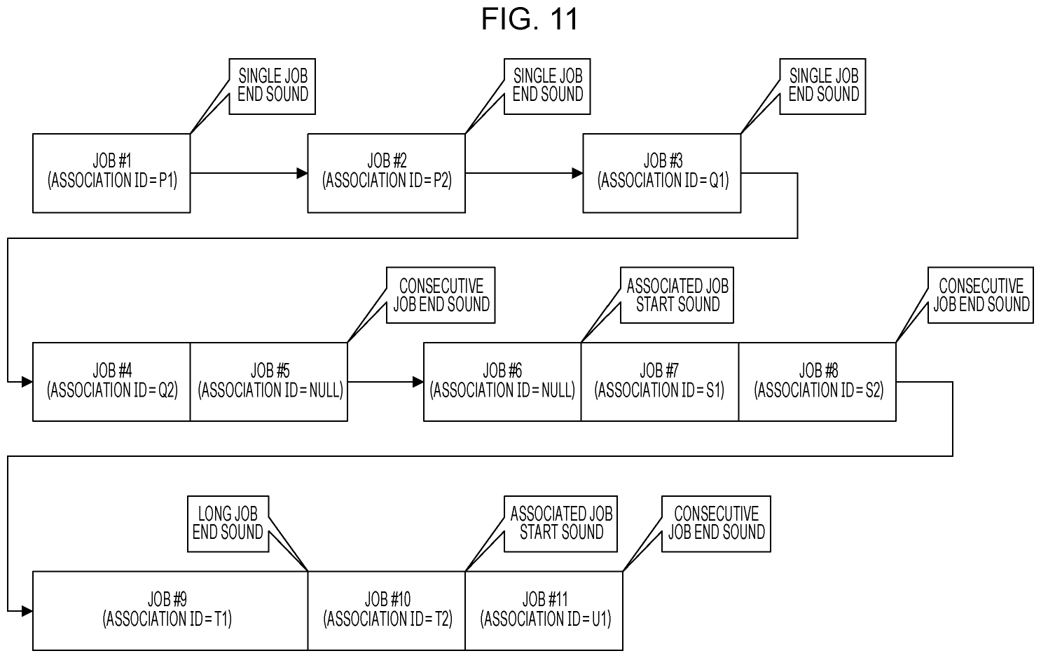

According to a fifth embodiment, as illustrated in FIG. 11, when jobs are consecutive, the multifunction peripheral outputs the consecutive job end sound every time a last job of the consecutive jobs ends, and when the jobs are not consecutive, the multifunction peripheral outputs the single job end sound every time each of the jobs ends. Thus, the multifunction peripheral does not output the job end sound when a job other than the last job included in the consecutive jobs ends.

Further, in the fifth embodiment, every time an associated job in the consecutive jobs starts, associated job start sound corresponding to a current associated job is output.

In an example of FIG. 11, since a job #4 and a job #5 are consecutive, the job end sound is not output when the #4 ends, and the consecutive job end sound is output when the job #5 ends.

Further, since a job #6, a job #7, and a job #8 are consecutive, the job end sound is not output when the job #6 and the job #7 end, and the consecutive job end sound is output when the job #8 ends.

Furthermore, since a job #9, a job #10, and a job #11 are consecutive, the job end sound is not output when the job #9 and the job #10 end, and the consecutive job end sound is output when the job #11 ends.

Though the job #4 and the job #5 are consecutive, an association ID of the job #4 is Q2, an association ID of the job #5 is NULL, and the job #4 and the job #5 are not associated with each other. However, since the job #5 is not originally associated with another job, associated job start sound is not output when the on #5 starts.

Though the job # 6, the job #7, and the job #8 are consecutive, an association ID of the job #6 is NULL, an association ID of the job #7 is S1, an association ID of the #8 is S2, and the job #6 and the job #7 are not associated with each other, and therefore, start sound of an associated job S is output when the job #7 starts.

Though the job #9, the job #10, and the job #11 are consecutive, an association ID of the job #9 is T1, an association ID of the job #10 is T2, an association ID of the job #11 is U1, and the job #10 and the job #11 are not associated with each other. Thus, start sound of an associated job U is output when the job #11 starts.

Since a job #1, a job #2, and a job #3 are not consecutive and are each a single job, the single job end sound is output every time each of the jobs ends.

Note that, the associated job start sound may be output when jobs which are associated with each other end and a job which is not originally associated with another job starts. In the example of FIG. 11, for example, the associated job start sound corresponding to NULL may be output when the job #5 starts.

Next, a job-related notification output method according to the fifth embodiment will be described.

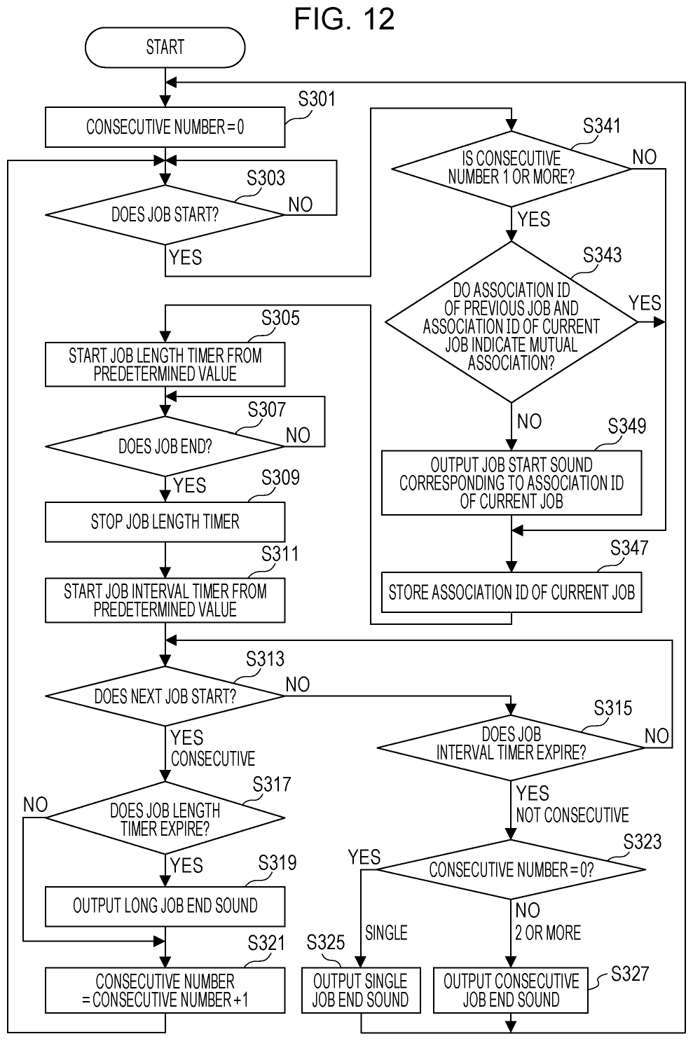

As is clear from FIG. 10 corresponding to the fourth embodiment and FIG. 12 corresponding to the fifth embodiment, the fifth embodiment is different from the fourth embodiment in that step S345 at which job end sound corresponding to a previous association ID is output is replaced with step S349 at which job start sound corresponding to a current association ID is output.

When the next association ID is NULL, job start sound corresponding to NULL may be output or nothing may be output at step S349.

Since the other steps are common, redundant description will be omitted.

### Sixth Embodiment

Setting of the multifunction peripheral may enable selection of any of the first embodiment through the fifth embodiment. In particular, setting by a manager or a user may enable selection of any of the embodiments in the same multifunction peripheral.

However, it is normal that the second embodiment and the third embodiment are mutually exclusively selected and also normal that the fourth embodiment and the fifth embodiment are mutually exclusively selected.

Though not illustrated in a flowchart, both step S331 to step S337 in the second embodiment and step S341 to step S347 in the fourth embodiment may be executed. That is, notification indicating that a user changes and notification indicating that an associated job starts or ends may be executed at the same time. Similarly, a combination of the second embodiment and the fifth embodiment, a combination of the third embodiment and the fourth embodiment, a combination of the third embodiment and the fifth embodiment, or the like may be configured. In a case where a plurality of types of notification are overlapped when the same job starts or ends, all the notification may be output by shifting time or only a part of the notification may be activated in accordance with predetermined priority order.

### Seventh Embodiment

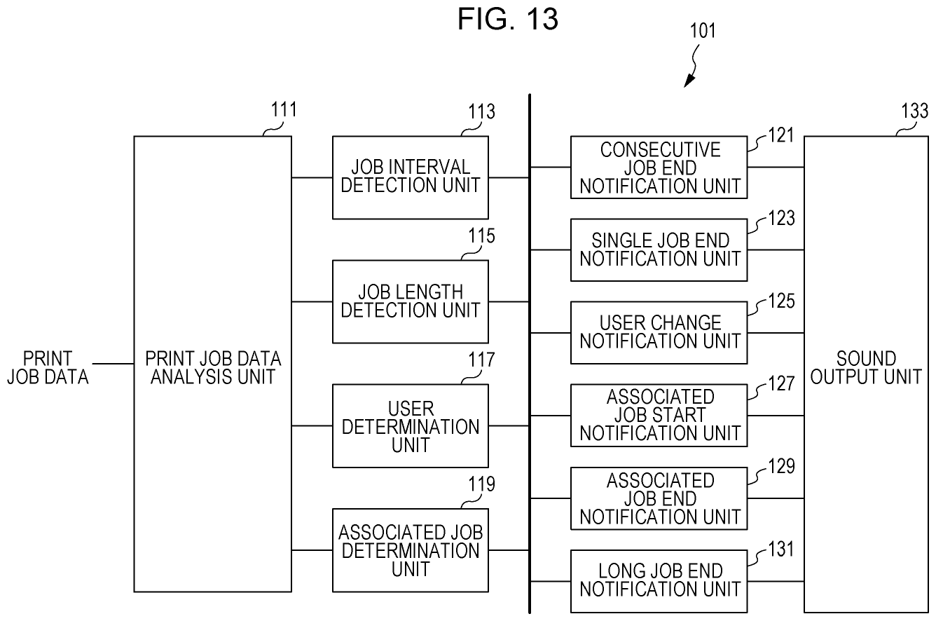

A functional block diagram illustrating a configuration of a job association output apparatus according to a seventh embodiment for executing the job-related notification output method according to the first through sixth embodiments is indicated in FIG. 13.

With reference to FIG. 13, a job association output apparatus 101 includes a print job data analysis unit 111, a job interval detection unit 113, a job length detection unit 115, a user determination unit 117, an associated job determination unit 119, a consecutive job end no unit 121, a single job end notification unit 123, a user change notification unit 125, an associated job start notification unit 127, an associated job end notification unit 129, a long job end notification unit 131, and a sound output unit 133.

The print job data analysis unit 111 accepts print job data and analyzes the data.

The job interval detection unit 113 detects a time interval between a job and a job subsequent thereto, and particularly detects whether the time interval is a predetermined value or less.

The job length detection unit 115 detects a time length of each job, and particularly detects whether the time length of each job is a predetermined length or more.

The user determination unit 117 determines a user of each job on the basis of a user ID included in each job, or the like.

The associated job determination unit 119 determines whether or not jobs are associated with each other on the basis of association IDs included in the jobs.

When consecutive jobs end, the consecutive job end notification unit 121 outputs sound indicating the end. A type of the sound may be one indicating the end or the end may be indicated by sound.

When a single job ends, the single job end notification unit 123 outputs sound indicating the end type of the sound may be one indicating the end or the end may be indicated by sound.

When a user changes, the user change notification unit 125 outputs sound indicating the change. A type of the sound may be one indicating the change or the change may be indicated by sound. In particular, to indicate a specific user, sound of a type corresponding to the user may be used or sound of a user name may be used.

When an associated job starts, the associated job start notification unit 127 outputs sound indicating the start. A type of the sound may be one indicating the start or the start may be indicated by sound.

When an associated job ends, the associated job end notification unit 129 outputs sound indicating the end. A type of the sound may be one indicating the end or the end may be indicated by sound.

When a long job ends, the long job end notification unit 131 outputs sound indicating the end. A type of the sound may be one indicating the end or the end may be indicated by sound.

The sound output unit 133 outputs sound to be output by the consecutive job end notification unit 121, the single job end notification unit 123, the user change notification unit 125, the associated job start notification unit 127, the associated job end notification unit 129, or the long job end notification unit 131.

### Eighth Embodiment

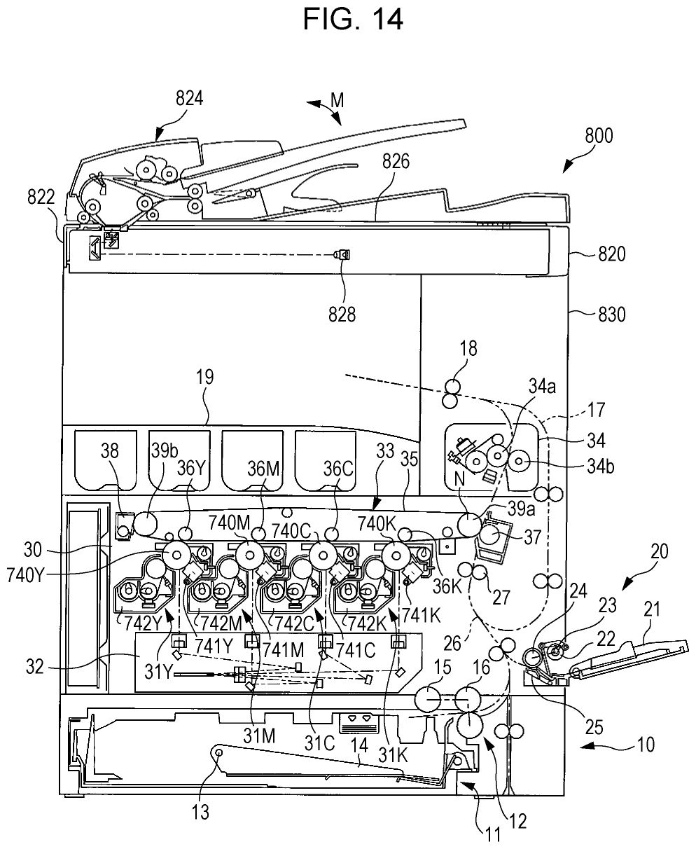

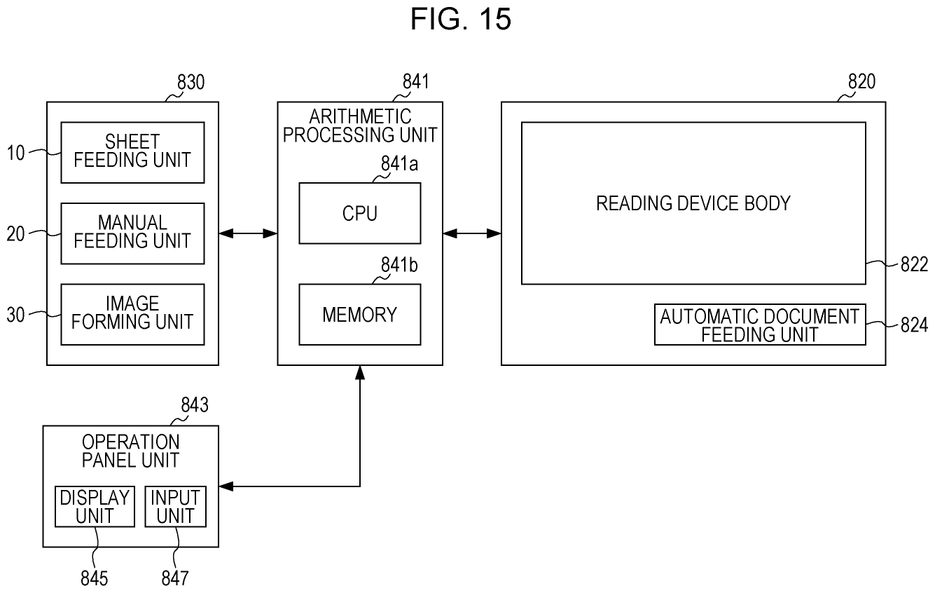

An eighth embodiment relates to a multifunction peripheral 800 including the job association output apparatus according to the seventh embodiment. FIGS. 14 and 15 illustrate a configuration of the multifunction peripheral 800 and the like.

As illustrated in FIGS. 14 and 15, the multifunction peripheral 800 includes a document, reading device 820 that reads an image of a document, a multifunction peripheral body (image forming unit body) 830 that form an image on a sheet, an operation panel unit 843 through which the document reading device 820 and the multifunction peripheral body 830 are operated, and an arithmetic processing unit 841 that controls the document reading device 820 and the multifunction peripheral body 830 on the basis of an operation by the operation panel unit 843.

The document reading device 820 may be used alone for reading the image or the multifunction peripheral body 830 may be used alone for forming the image, or alternatively, the document reading device 820 and the multifunction peripheral body 830 may operate in conjunction with each other for copying the image. The multifunction peripheral 800 may include a storage device and a facsimile device (not illustrated). The storage device is able to store an image read by the document reading device 820 or an image received by the facsimile device. The facsimile device is able to transmit the image read by the document reading device 820 or the image stored in the storage device and to receive the image from outside. Further, the multifunction peripheral 800 may include an interface for connecting with a personal computer via a network. The personal computer connected to the multifunction peripheral 800 is able to use a function of the multifunction peripheral for data which the personal computer is able to manage.

The document reading device 820 includes an automatic document feeding unit (single pass feeder: SPF) 824 that automatically feeds a document and a reading device body 822 that reads the image of the document. Note that, in addition to the components illustrated in FIG. 15, the document reading device 820 also includes components which are not illustrated in FIG. 15 but which are illustrated in FIG. 14. Further, as illustrated in FIG. 14, the reading device body 822 includes a document table 826.

The multifunction peripheral body 830 includes a sheet feeding unit 10 that feeds the sheet, a manual feeding unit 20 that enables manual feeding of the sheet, and an image forming unit 30 that forms the image on the sheet fed by the sheet feeding unit 10 or the manual feeding unit 20.

The sheet feeding unit 10 includes a sheet loading unit 11 on which the sheet is loaded and a separate feeding unit 12 that separately feeds the sheet, which is loaded on the sheet loading unit 11, one by one. The sheet loading unit 11 includes a middle plate 14 that pivots around a rotation shaft 13 and the middle plate 14 pivots and lifts the sheet upward when the sheet is fed. The separate feeding unit 12 includes a pickup roller 15 that feeds the sheet lifted by the middle plate 14 and a separation roller pair 16 that separates the sheet, which is fed by the pickup roller 15, one by one.

The manual feeding unit 20 includes a manual feed tray 21 on which the sheet is able to be loaded and a separate feeding unit 22 that separately feeds the sheet, which is loaded on the manual feed tray 21, one by one. The manual feed tray 21 is rotatably supported by the multifunction peripheral body 830 and enables loading of the sheet by being fixed at a predetermined angle when the sheet is manually fed. The separate feeding unit 22 includes a pickup roller 23 that feeds the sheet loaded on the manual feed tray 21, and a separation roller 24 and a separation pad 25 that separate the sheet, which is fed by the pickup roller 23, one by one.

The image forming unit 30 includes four process cartridges 31Y to 31K that form images of yellow (Y), magenta (M), cyan (C), and black (K), photosensitive drums 740Y to 740K described below, an exposure device 32 that exposes surfaces of the photosensitive drums 740Y to 740K, a transfer unit 33 that transfers toner images, which are formed on the surfaces of the photosensitive drums 740Y to 740K, to the sheet, and a fixing unit 34 that fixes the transferred toner images to the sheet. Note that, the letters of the alphabet (Y, M, C, and K) appended to the reference numerals indicate the respective colors (yellow, magenta, cyan, and black).

Each of the four process cartridges 31Y to 31K is configured to be detachable from the multifunction peripheral body 830 and is exchangeable. Note that, since the four process cartridges 31Y to 31K have similar configurations except that the colors of the images to be formed are different, only the configuration of the process cartridge 31Y that forms the image of yellow (Y) will be described, and the description for the process cartridges 31M to 31K will be omitted.

The process cartridge 31Y includes the photosensitive drum 740Y as an image carrier, a charger 741Y that charges the photosensitive drum 740Y, a developing device 742Y that develops an electrostatic latent image formed on the photosensitive drum 740Y, and a drum cleaner that removes toner remaining on the surface of the photosensitive drum 740Y. The developing device 742Y includes a developing device body (not illustrated in detail) that performs development on the photosensitive drum 740Y, and a toner cartridge (not illustrated in detail) that supplies toner to the developing device body. The toner cartridge is configured to be attachable to and detachable from the developing device body, and when the stored toner is exhausted, the toner cartridge is able to be detached from the developing device body and exchanged.

The exposure device 32 includes a light source (not illustrated) that radiates a laser beam, a plurality of mirrors (not illustrated) that guide laser beams to the photosensitive drums 740Y to 740K, and the like. The transfer unit 33 includes an intermediate transfer belt 35 that carries the toner images formed on the photosensitive drums 740Y to 740K, primary transfer rollers 36Y to 36K that primarily transfer the toner images formed on the photosensitive drums 740Y to 740K to the intermediate transfer belt 35, a secondary transfer roller 37 that secondarily transfers the toner images transferred to the intermediate transfer belt 35 to the sheet, and a belt cleaner 38 that removes the toner remaining on the intermediate transfer belt 35. The intermediate transfer belt 35 is wound around a driving roller 39a and a driven roller 39b and is pushed against the photosensitive drums 740Y to 740K by the primary transfer rollers 36Y to 36K. The secondary transfer roller 37 nips (holds) the intermediate transfer belt 35 with the driving roller 39a and transfers the toner images carried by the intermediate transfer belt 35 to the sheet at a nip portion N. The fixing unit 34 includes a heating roller 34a that heats the sheet and a pressure roller 34b that applies pressure to the heating roller 34a.

The operation panel unit 843 includes a display unit 845 that displays predetermined information and an input unit 847 through which a user inputs an instruction to the document reading device 820 and the multifunction peripheral body 830. In the present embodiment, the operation panel unit 843 is disposed on a front side of the reading device body 822. Note that, the front side corresponds to a near side of FIG. 14 and a back side corresponds to a rear side of FIG. 14.

As illustrated in FIG. 15, the arithmetic processing unit 841 includes a CPU 841a that controls driving of the sheet feeding unit 10, the manual feeding unit 20, the image forming unit 30, and the document reading device 820 and a memory 841b in which various programs for operating the CPU 841a, various kinds of information used by the CPU 841a, and the like are stored. The arithmetic processing unit 841 integrally controls operations of the sheet feeding unit 10, the manual feeding unit 20, the image forming unit 30, and the document reading device 820 on the basis of an operation by the user on the operation panel unit 843, to form an image on a sheet.

Next, an image formation operation (image formation control performed by the arithmetic processing unit 841) performed by the multifunction peripheral 800 having the configuration as described above will be described. In the present embodiment, an image formation operation will be described as an example in which the image forming unit 30 forms an image, which is read by the reading device body 822, of a document fed by the automatic document feeding unit 824, on a sheet fed by the sheet feeding unit 10.

When an image formation start signal is transmitted by an input to the input unit 847 of the operation panel unit 843 by the user, a document to be read placed on the automatic document feeding unit 824 by the user is automatically fed toward a document reading position and the reading device body 822 reads an image at the document reading position.

When the reading device body 822 reads the image of the document, the exposure device 32 radiates a plurality of laser beams corresponding to the respective photosensitive drums 740Y to 740K toward the photosensitive drums 740Y to 740K on the basis of image information of the document that is read. At this time, the photosensitive drums 740Y to 740K are respectively charged in advance by the chargers 741Y to 741K, and when the respective photosensitive drums 740Y to 740K are irradiated with the laser beams corresponding thereto, electrostatic latent images are formed on the photosensitive drums 740Y to 740K. After that, the respective electrostatic latent images formed on the photosensitive drums 740Y to 740K are developed by the developing devices 742Y to 742K and toner images of yellow (Y), magenta (M), cyan (C), and black (K) are formed on the photosensitive drums 740Y to 740K. The toner images of the respective colors formed on the photosensitive drums 740Y to 740K are superimposed and transferred to the intermediate transfer belt 35 by the primary transfer rollers 36Y to 36K and the toner image (full-color toner image) obtained through the superimposition transfer is conveyed to the nip portion N while being carried on the intermediate transfer belt 35.

In parallel to the image formation operation described above, the sheet loaded on the sheet loading unit 11 is fed to a sheet conveyance path 26 by the pickup roller 15 while being separated one by one by the separate feeding unit 12. Then, a registration roller pair 27 positioned on the upstream of the nip portion N in a sheet conveyance direction corrects oblique orientation of the sheet, and the sheet is conveyed to the nip portion N at a predetermined conveying timing. The full color toner image carried on the intermediate transfer belt 35 is transferred by the secondary transfer roller 37 onto the sheet conveyed to the nip portion N.

The sheet on which the toner image is transferred is heated and pressed by the fixing unit 34 so that the toner image is melted and fixed, and the sheet is discharged outside the apparatus by a discharge roller pair 18. The sheet discharged to the outside of the apparatus is loaded on a discharged sheet loading unit 19.

Note that, when images are to be formed on both sides (a first side and a second side) of a sheet, before the sheet on which an image has been formed on the first side is discharged to the outside of the apparatus, the discharge roller pair 18 is rotated in an opposite direction so that the sheet is conveyed to a duplex conveyance path 17 and is conveyed again to the image forming unit 30 through the duplex conveyance path 17. Then, similarly to the first side, an image is formed on the second side, and the sheet is discharged to the outside of the apparatus. The sheet discharged to the outside of the apparatus is loaded on the discharged sheet loading unit 19.

Though description related to a print job has been given in the aforementioned embodiments, the embodiments are also applicable to another type of job.

In addition, the embodiments are also applicable to an apparatus other than the multifunction peripheral.

Further, one that is output may not be sound. For example, an image or a character may be output.

Note that, the aforementioned job association output apparatus is able to be implemented by hardware, software, or a combination thereof. The job-related notification output method performed by the aforementioned job association output apparatus is also to be implemented by hardware, software, or a combination thereof. Here, Implementation by software means implementation by a computer reading a program for execution.

The program is able to be stored by using various types of non-transitory computer readable media and supplied to a computer. The non-transitory computer readable media include various types of tangible storage media. Examples of the non-transitory computer readable media include a magnetic storage medium (for example, flexible disk, magnetic tape, or hard disk drive), a magneto-optical storage medium (for example, magneto-optical disk), a CD-ROM (Read Only Memory), a CD-R, a CD-R/W, and a semiconductor memory (for example, a mask ROM, a PROM (Programmable ROM), an EPROM (Erasable PROM), a flash ROM, or a RAM (random access memory)). In addition, the program may be supplied to the computer by using various types of transitory computer readable media. Examples of the transitory computer readable media include an electrical signal, an optical signal, and an electromagnetic wave. The transitory computer readable media are able to supply the program to the computer via a wired communication line such as a wire or an optical fiber or a wireless communication line.

The disclosure is able to be implemented in various different forms without departing from the spirit and the principal characteristics of the disclosure. Therefore, the embodiments described above are merely exemplary, and are not to be interpreted restrictively. The scope of the disclosure is indicated by the claims, and is not restricted by the specification description body. Further, chancre and modification belonging to the scope equivalent to the claims are all included in the scope of the present disclosure.

The disclosure is able to be utilized for output of sound related to a job.

The present disclosure contains subject matter related to that disclosed in Japanese Priority Patent Application JP 2018-130610 filed in the Japan Patent Office on Jul. 10, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A job-related notification output apparatus comprising:
a consecutive job end notification unit that, when consecutive jobs end, outputs notification indicating that the consecutive jobs end; and
a single job end notification unit that, when a single job ends, outputs notification indicating that the single job ends.

2. The job-related notification output apparatus according to claim 1, further comprising
a user change notification unit that, when a user of a job changes, outputs notification indicating that the user changes.

3. The job-related notification output apparatus according to claim 2, wherein
the user change notification unit outputs the notification corresponding to a user before or after the change.

4. The job-related notification output apparatus according to claim 1, further comprising
an associated job start notification unit that, when a first job included in a plurality of jobs associated with each other starts, outputs notification indicating the start.

5. The job-related notification output apparatus according to claim 1, further comprising
an associated job end notification unit that, when a last job included in a plurality of jobs associated with each other ends, outputs notification indicating the end.

6. The job-related notification output apparatus according to claim 1, further comprising
a long job end notification unit that, when a job taking a predetermined time or more ends, outputs notification indicating the end.

7. A multifunction peripheral comprising the job-related notification output apparatus according to claim 1.

8. An image forming apparatus comprising the job-related notification output apparatus according to claim 1.

9. A job-related notification output method comprising:
outputting, when consecutive jobs end, notification indicating that the consecutive jobs end; and
outputting, when a single job ends, notification indicating that the single job ends.

10. A recording medium storing a program that causes a computer to function as the job-related notification output apparatus according to claim 1.
